(19) United States
(12) Patent Application Publication
(10) Pub. No.: US 2025/0044779 A1
(43) Pub. Date: Feb. 6, 2025

(54) PROCESS MODEL CREATION SYSTEM, PROCESS MODEL CREATION METHOD AND PROCESS MODEL CREATION PROGRAM

(71) Applicant: Hitachi, Ltd., Tokyo (JP)

(72) Inventors: Takehiro HAGIWARA, Tokyo (JP); Hitoshi ISHIDA, Tokyo (JP); Riku KAWAMURA, Tokyo (JP); Ikumi INOUE, Tokyo (JP); Tomohiro MATSUDA, Tokyo (JP); Hiroki MIYAMOTO, Tokyo (JP)

(21) Appl. No.: 18/436,829

(22) Filed: Feb. 8, 2024

(30) Foreign Application Priority Data
Aug. 3, 2023 (JP) 2023-126835

(51) Int. Cl. G05B 19/418; G06F 16/25; G06Q 50/04

(52) U.S. Cl. CPC G05B 19/41885; G06F 16/258; G06Q 50/04

(57) ABSTRACT

Proposed are a process model creation system, a process model creation method and a process model creation program capable of reducing the man-hours required for generating a process model without having to prepare a process model for each of the plurality of business systems. The present invention comprises a data structure conversion unit which converts each data of each business system into a data structure of a common BOP (Bill of Process), a model generation unit which creates a plurality of adapter models from the data structure of the common BOP, and a process model synthesis unit which extracts differences between the plurality of adapter models and creates a synthesis process model.

### CROSS-REFERENCE TO RELATED APPLICATION

The present application claims priority from Japanese application JP2023-126835, filed on Aug. 3, 2023, the contents of which is hereby incorporated by reference into this application.

### TECHNICAL FIELD

The present invention relates to a process model creation system, a process model creation method and a process model creation program and, for example, can be suitably applied to a process model creation system for creating a process model capable of linking on-site data and design data from on-site data generation devices arranged in the factory's production equipment.

### BACKGROUND ART

In recent years, a method of arranging numerous data collection equipment on the production line of the factory's production equipment, and collecting on-site data in real-time using such numerous data collection equipment, is being performed. The on-site data collected is accumulated as a data lake on a platform.

As a method of collecting and managing on-site data, there is the method described in PTL 1. PTL 1 generates a process model, which is a modelization of the manufacturing process, and manages on-site data by linking it with the process model. Meanwhile, as a method of generating a model of the process flow from data, there is the method described in PTL 2. PTL 2 modelizes the process flow by “creating flow information in which the names of the updated data aggregate are arranged in the order of their updated time”.

### CITATION LIST

### Patent Literature

[PTL 1] Japanese Unexamined Patent Application Publication No. 2019-153051
[PTL 2] International Publication No. 07/132547

### SUMMARY OF THE INVENTION

### Problems to be Solved by the Invention

Based on the disclosed foregoing Patent Literature, considered may be generating a process model for managing on-site data of a manufacturing site from the data being managed by a business system at the manufacturing site. Nevertheless, generally speaking, a plurality of business systems is operating at a manufacturing site, and the data structure of the data being managed by each business system is different. Thus, when creating a process model from the data being managed by a business system, it is necessary to prepare a generation function of the process model for each of the plurality of business systems. Consequently, each time a business is added to each business system or a business of each business system is changed, it was necessary to develop individual functions for each business system. In addition, because the granularity of the definition of the business process is different for each business system, even when comparing the process models of a plurality of business systems, it was difficult to comprehend the differences between the process models. This type of problem is not unique to manufacturing sites in the manufacturing business, and also exists in companies of various other industries. For example, similar problems exist in industries having a series of processes configured from a plurality of businesses and in which a plurality of business systems are operating, such as the logistics business, retail business or service business.

The present invention was devised in view of the foregoing points, and an object of this invention is to propose a process model creation system, a process model creation method and a process model creation program capable of reducing the man-hours required for generating a process model without having to prepare a process model for each of the plurality of business systems.

### Means to Solve the Problems

In order to achieve the foregoing object, the present invention comprises a data structure conversion unit which converts each data of each business system into a data structure of a common BOP (Bill of Process), a model generation unit which creates a plurality of adapter models from the data structure of the common BOP, and a process model synthesis unit which extracts differences between the plurality of adapter models and creates a synthesis process model.

The present invention comprises a data structure conversion step of a data structure conversion unit of a process model creation system converting each data of each business system into a data structure of a common BOP (Bill of Process), a model generation step of a model generation unit of a process model creation system creating a plurality of adapter models from the data structure of the common BOP, and a process model synthesis step of a process model synthesis unit of a process model creation system extracting differences between the plurality of adapter models and creating a synthesis process model.

The present invention causes a computer to execute a data structure conversion step of causing a data structure conversion unit of a process model creation system to convert each data of each business system into a data structure of a common BOP (Bill of Process), a model generation step of causing a model generation unit of a process model creation system to create a plurality of adapter models from the data structure of the common BOP, and a process model synthesis step of causing a process model synthesis unit of a process model creation system to extract differences between the plurality of adapter models and create a synthesis process model.

According to the foregoing configuration, the process model synthesis unit can generate a synthesis process model based on the differences between the plurality of adapter models.

### Advantageous Effects of the Invention

According to the present invention, it is possible to realize a process model creation system, a process model creation method and a process model creation program capable of reducing the man-hours required for generating a process model without having to prepare a process model for each of the plurality of business systems.

### BRIEF DESCRIPTION OF DRAWINGS

FIG. 1 is a block diagram showing a system configuration example of the process model creation system according to the present embodiment.

FIG. 2 is a block diagram showing an example of the function of the process model creation system according to the present embodiment.

FIG. 3 is a diagram showing an example of the sequence of the model generation for generating a synthesis process model.

FIG. 4A is a diagram showing an example of the design data.

FIG. 4B is a diagram showing an example of the on-site data.

FIG. 5 is a diagram showing an example of the relationship of the manufacturing process and businesses.

FIG. 6 is a diagram showing a configuration example of the schema model.

FIG. 7 is a diagram showing an example of the performance instance.

FIG. 8 is a flowchart showing an example of the routine of the adapter function processing performed by the adapter function unit.

FIG. 9 is a flowchart showing an example of the routine of the model generation processing.

FIG. 10 is a flowchart showing an example of the routine of the model synthesis processing.

FIG. 11 is a flowchart showing an example of the routine of the performance instance creation processing.

FIG. 12 is a diagram showing an example of the process catalog.

FIG. 13 is a diagram showing a creation example of the process catalog.

FIG. 14 is a diagram showing a creation example of the process catalog.

FIG. 15 is a diagram showing a creation example of the process catalog.

FIG. 16 is a diagram showing an assistance example in creating the process catalog.

### DESCRIPTION OF EMBODIMENTS

An embodiment of the present invention is now explained in detail with reference to the appended drawings.

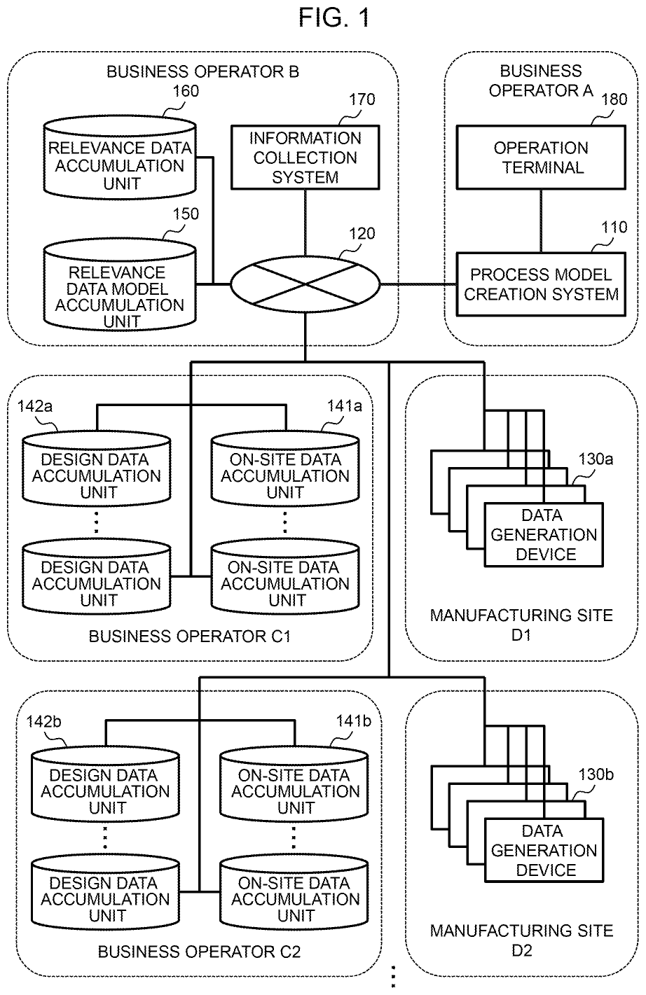

FIG. 1 is a block diagram showing a system configuration example of a process model creation system 100 according to the present embodiment. The process model creation system 100 includes a business operator A, a business operator B, a business operator C1, a business operator C2, a manufacturing site D1 and a manufacturing site D2. Note that the manufacturing site D1 shows the manufacturing site of the business operator C1, and the manufacturing site D2 shows the manufacturing site of the business operator C2.

The manufacturing site D1 is provided with a plurality of data generation devices 130a, and the plurality of data generation devices 130a is provided to the manufacturing equipment of the manufacturing site D1 and collects on-site data of the manufacturing equipment of the manufacturing site D1. The plurality of data generation devices 130a is connected to a network 120.

The manufacturing site D2 is provided with a plurality of data generation devices 130b, and the plurality of data generation devices 130a is provided to the manufacturing equipment of the manufacturing site D2 and collects on-site data of the manufacturing equipment of the manufacturing site D2. The plurality of data generation devices 130b is connected to a network 120.

The business operator A comprises an operation terminal 180 and a process model creation system 110. The operation terminal 180 is an operation device to be operated by a user, and, as a result of the instructions according to such operation being given to the process model creation system 110, the process model creation system 110 creates a synthesis process model that can be used commonly in a plurality of business systems. In other words, in the present embodiment, the functions for creating a process model are consolidated in the process model creation system 110, and the configuration is such that each business system is not required to be equipped with functions for creating a process model. Because the process model itself is not essential for the operation of each business system, this is based on the concept that the information collection system 170 needs to prepare a process model creation function for managing the data of each business system, rather than the concept that each business system requires functions for creating a process model. The process model creation system 110 is a so-called computer comprising, for example, a central processing unit and a storage unit, and is configured so that it can execute the process model creation program described later using such central processing unit, storage unit and so on.

A process model may include a business node corresponding to each business, a material node corresponding to the materials of each business, and a related information node concerning so-called 4M data items. 4M refers to the elements of huMan, Machine, Method, and Material. Moreover, related information may also be 1M to 3M information that does not include one among the 4M information. Moreover, related information may also include information of the quality of products for which business was conducted. Moreover, business related information may include information concerning the environment (Environment) and information concerning the management condition (Management) in which the business was conducted. Note that there are cases where the material node becomes an input product (part) or an output product (finished product or part) of a business node. The flow of whether the material node becomes an input product or an output product relative to the business node is also expressed as a “process flow”. The related information node linked to the business node stores the 4M data items related to the corresponding business. Moreover, in the present embodiment, the flow configured from a plurality of businesses can also be expressed as a “process”. Here, let it be assumed that the identifier which identifies the materials in the process will not be changed.

The business operator B comprises a relevance data model accumulation unit 150, a relevance data accumulation unit 160, an information collection system 170 and a network 120, and the relevance data model accumulation unit 150, the relevance data accumulation unit 160 and the information collection system 170 are connected to the network 120. Note that the network 120 may also exist outside the business operator B.

The business operator C1 comprises a plurality of on-site data accumulation units 141a and a plurality of design data accumulation units 142a. The plurality of on-site data accumulation units 141a and the plurality of design data accumulation units 142a are connected to the network 120.

In the plurality of on-site data accumulation units 141a, for example, the on-site data generated by the data generation device 130a of the manufacturing site D1 are collected and accumulated via the network 120.

In the plurality of design data accumulation units 142a, for example, the design data concerning the products of the manufacturing site D1 are collected and accumulated via the network 120. Here, the design data includes the part's part number, format, product specification, and product attribute, and configuration information of products such as the quantity.

The business operator C2 comprises a plurality of on-site data accumulation units 141b and a plurality of design data accumulation units 142b. The plurality of on-site data accumulation units 141b and the plurality of design data accumulation units 142b are connected to the network 120.

In the plurality of on-site data accumulation units 141b, for example, the on-site data generated by the data generation device 130a of the manufacturing site D1 are collected and accumulated via the network 120.

In the plurality of design data accumulation units 142b, for example, the design data concerning the products of the manufacturing site D1 are collected and accumulated via the network 120.

Note that, in the present embodiment, when there is no particular need to differentiate the on-site data accumulation unit 141a and the on-site data accumulation unit 141b, they will be collectively indicated as “on-site data accumulation unit 141”, and when there is no particular need to differentiate the design data accumulation unit 142a and the design data accumulation unit 142b, they will be collectively indicated as “design data accumulation unit 142”.

As described above, in the present embodiment, business systems are operating separately for each of a plurality of business operators, and, with the business operator A, the user needs to operate the operation terminal 180 and create a synthesis process model (hereinafter also referred to as the “schema model”) that is common among the respective business operators by using the process model creation system 110. This is now explained in detail.

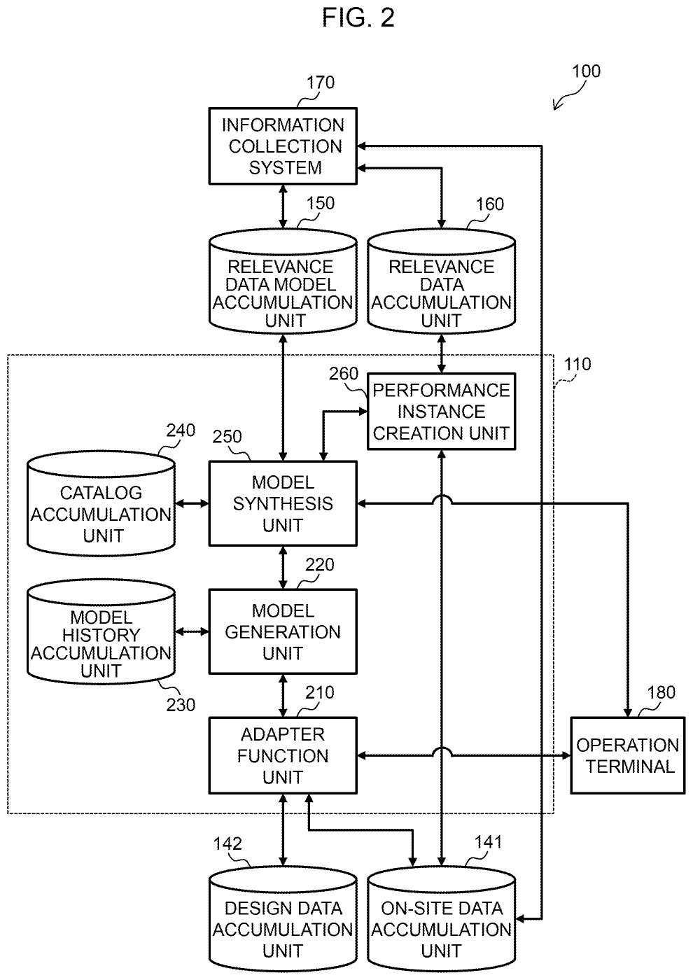

FIG. 2 is a block diagram showing an example of the function of the process model creation system 100 according to the present embodiment. As described above, the on-site data accumulation unit 141 sequentially accumulates on-site data generated by the data generation device 130a and the data generation device 130b, and the design data accumulation unit 142 accumulates, for example, design data concerning the products of the manufacturing site D1 and the products of the manufacturing site D2.

In the present embodiment, the process model creation system 100 comprises an adapter function unit 210 as an example of the data structure conversion unit which converts each data of each business system into a data structure of a common BOP (Bill of Process), a model generation unit 220 which creates a plurality of adapter models from the data structure of the common BOP, and a model synthesis unit 250 as an example of the process model synthesis unit which extracts differences between the plurality of adapter models and creates a synthesis process model. Here, as each data described above, considered may be, for instance, BOP, design data, and on-site data.

The process model creation system 110 described above comprises a performance instance creation unit 260, an adapter function unit 210, a model history accumulation unit 230, a model generation unit 220, a catalog accumulation unit 240, and a model synthesis unit 250.

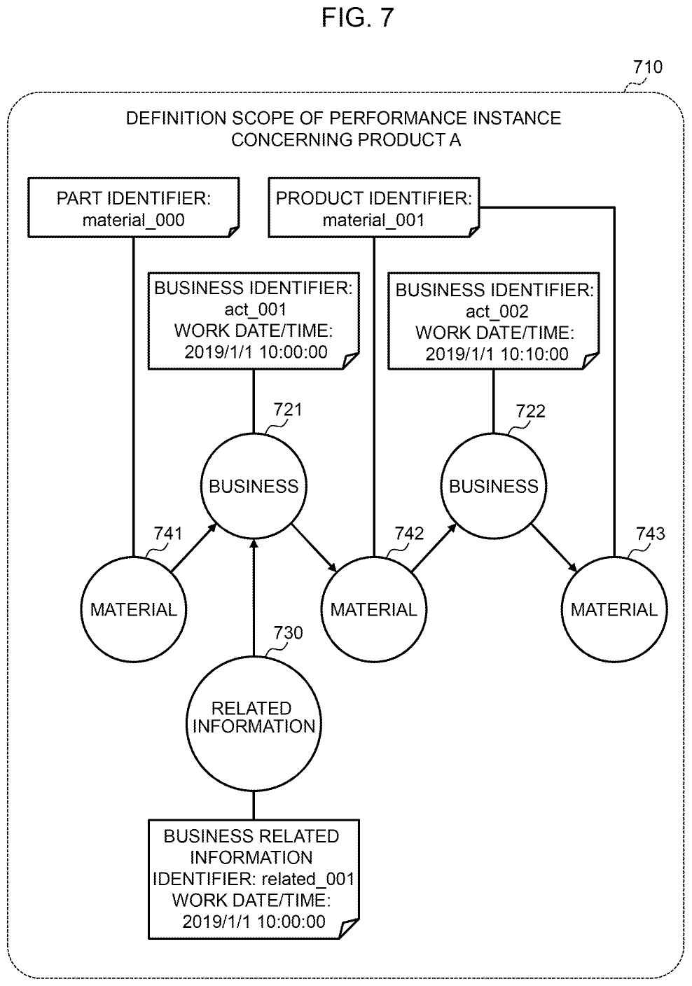

The performance instance creation unit 260 creates a performance instance (see FIG. 7 described later) from the on-site data accumulated in the on-site data accumulation unit 141, and accumulates, in the relevance data accumulation unit 160, relevance data showing the relevance between the respective businesses and the relevance with each on-site data linked to each business in the manufacturing process.

The adapter function unit 210 converts the BOP (Bill of Process) of each business system into a common BOP. Specifically, the adapter function unit 210 converts the data (on-site data, design data) held by each business system into a common BOP data structure. In the following explanation, a BOP that is common is also referred to a “common BOP”. In the present embodiment, as this type of conversion example, in order to output a certain item, a common BOP is obtained by defining the item to be used as the input and the process to be input, and defining the manufacturing process as the transition of the item. Moreover, in the present embodiment, a common BOP may also be obtained by defining the business to be input in the process of inputting the item. Moreover, in the present embodiment, the process taken by the same item may be defined by defining the anteroposterior relationship relative to the process. Moreover, in the present embodiment, the order relationship between businesses may be defined in the process configured from a plurality of businesses. Furthermore, in the present embodiment, related resources (=4M) may be defined by assigning them to the process or the business.

The model generation unit 220 creates an adapter model with the data of the common BOP as the input. The model generation unit 220 generates an adapter model in which the relevance of each business, each material of each business and other related information is defined based on, for instance, input data such as each business, each material of each business and other related information, and registers the generated adapter model in the model history accumulation unit 230.

The model history accumulation unit 230 stores the adapter model created by the model generation unit 220. The adapter model is used for converting the data structure of the process model.

The catalog accumulation unit 240 accumulates the process catalog, which is each process definition. The process catalog is defined with a relationship between constituent elements of a plurality of adapter models for comparing the differences between a plurality of adapter models.

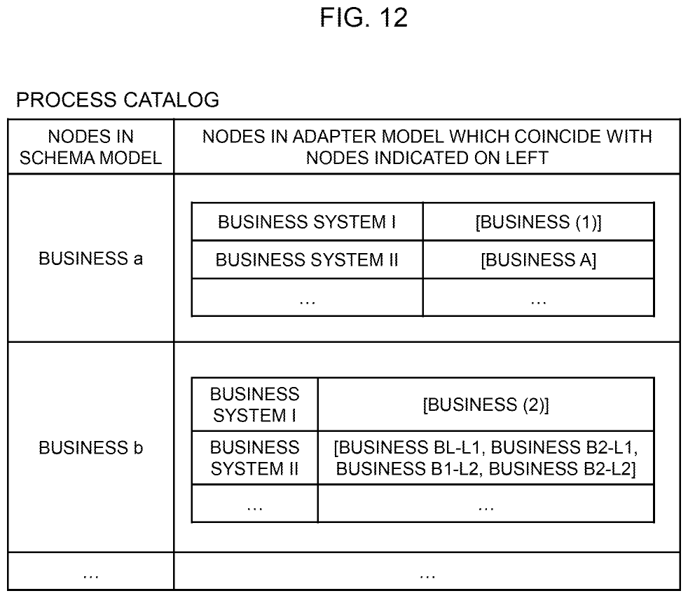

A process catalog is, for example, a definition of a node, for each node in the schema model, in the adapter model that coincides with the corresponding node (for example, lowest parts of FIG. 12 and FIG. 13 to FIG. 16 described later). As an example of the process catalog, there is a business (node) of the business system of the adapter model corresponding to the business (node) of the schema model.

The model synthesis unit 250 includes a difference extraction function which extracts differences between adapter models, and creates a synthesis process model based on the differences between the adapter models extracted by the difference extraction function.

As the mode of use of the common BOP in the present embodiment, for instance, considered may be recommending that the businesses linked by the related information coincide from the related information concerning the businesses in each process model; for instance, from the similarity of the so-called 4M data items. The creation of a process catalog is assisted (catalog creation assistance unit) based on this kind of recommendation. As a specific example of this mode of use, for instance, considered may be that the business is being conducted within the same factory, the same equipment is being used for the business, or the same worker is in charge of the business. Moreover, as a specific example of this mode of use, considered may be recommending that the businesses coincide from the similarity of the names of the respective businesses in each process model. Otherwise, as a specific example of this mode of use, considered may be changing the accuracy of the recommendation in accordance with from which information the coincidence of the businesses is estimated pursuant to the order of BOE (Bill of Equipment)>BOM (Bills of Material)>BOP (Bill of Process).

The model synthesis unit 250 is an example of the process model synthesis unit and, as described above, generates a synthesis process model as a schema model capable of linking all of the data in a plurality of business systems by giving consideration to the differences extracted by the difference extraction function.

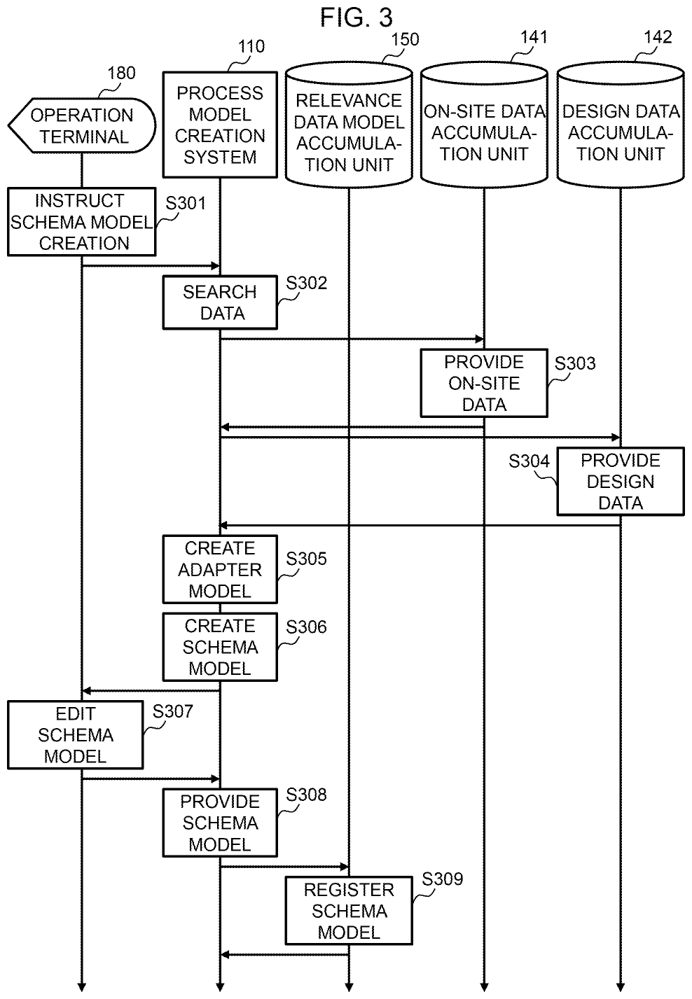

FIG. 3 is a diagram showing an example of the sequence of the model generation for generating a synthesis process model. In the present embodiment, the process model creation method is executed by the process model creation system 100 executing the process model creation program, and, specifically, the process model creation program causes a computer to execute a data structure conversion step of causing the adapter function unit 210, as an example of the data structure conversion unit, of the process model creation system 100 to convert each data of each business system into a data structure of a common BOP, a model generation step of causing the model generation unit 220 of the process model creation system 100 to create a plurality of adapter models from the data structure of the common BOP, and a process model synthesis step of causing the model synthesis unit 250 of the process model creation system 100 to extract differences between the plurality of adapter models and creating a synthesis process model. This is now explained in detail.

Foremost, in step S301, the user operates the operation terminal 180 and issues instructions to the process model creation system 110 for creating a schema model. The term “schema model” referred to herein means the synthesis process model, and in the following explanation, this schema model is also sometimes indicated as the synthesis process model.

In step S302, the process model creation system 110 executes a data search. Specifically, the process model creation system 110 issues instructions to the on-site data accumulation unit 141 to provide on-site data, and issues instructions to the design data accumulation unit 142 to provide design data.

In step S303, when the on-site data accumulation unit 141 receives instructions to provide on-site data from the process model creation system 110, the on-site data accumulation unit 141 provides on-site data to the process model creation system 110.

In step S304, when the design data accumulation unit 142 receives instructions to provide design data from the process model creation system 110, the design data accumulation unit 142 provides design data to the process model creation system 110.

In step S305, the process model creation system 110 creates an adapter model. Here, the adapter model is used for converting the data structure of the process model in order to communalize the data structure of the process model of each business system in substitute for each business system creating each process model as conventionally. Consequently, each business system is no longer required to independently generate a process model.

In step S306, the process model creation system 110 creates a schema model. The process model creation system 110 provides the created schema model to the operation terminal 180.

In step S307, the user operates the operation terminal 180 and edits the schema model as needed, and provides the edited schema model as the synthesis process model to the process model creation system 110. In the present embodiment, the schema model and the synthesis process model are explained as being basically synonymous.

In step S308, the process model creation system 110 provides the edited schema model to the relevance data model accumulation unit 150. In step S309, the edited schema model is registered in the relevance data model accumulation unit 150.

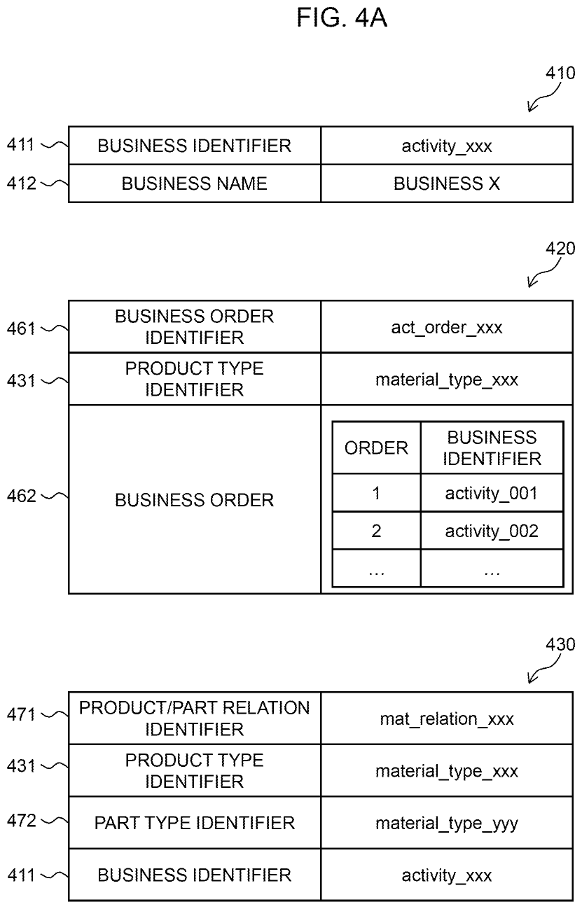

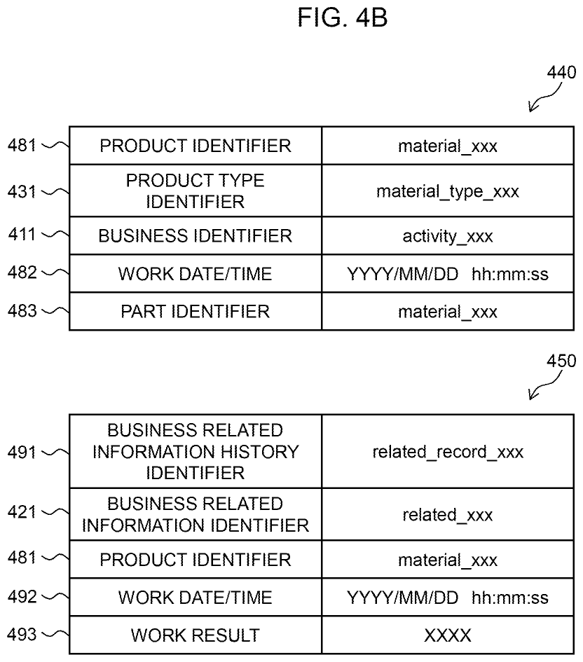

FIG. 4A is a diagram showing an example of the design data. FIG. 4A illustrates three types of design data. The design data 410 indicated at the upper part of FIG. 4A is managing a business identifier 411 and a business name 412 for mutually identifying the respective businesses. The design data 420 shown at the center of FIG. 4B is managing a business order identifier 461, a product type identifier 431 and a business order 462 of the business. The design data 430 shown at the lower part of FIG. 4A is managing a product/part relation identifier 471, a product type identifier 431, a part type identifier 472 and a business identifier 411. In other words, the design data is managing, for example, information related to the business order, product type, business order, relationship of product and part, product type and part type in the manufacturing process of each business.

FIG. 4B is a diagram showing an example of the on-site data. FIG. 4B illustrates two types of on-site data. The on-site data 440 shown at the upper part of FIG. 4B is managing a product identifier 481, a product type identifier 431, a business identifier 411, a work date/time 482 and a part identifier 483. The on-site data 450 shown at the lower part of FIG. 4B is managing a business related information history identifier 491, a business related information identifier 421, a product identifier 481, a work date/time 492 and a work result 493.

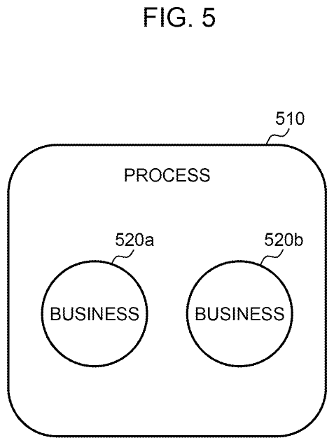

FIG. 5 is a diagram showing an example of the relationship of the manufacturing process and businesses. The manufacturing process 510 includes a plurality of businesses; for example, a business 520a and a business 520b. In other words, the manufacturing process 510 shows the possibility that the business 520a and the business 520b are related.

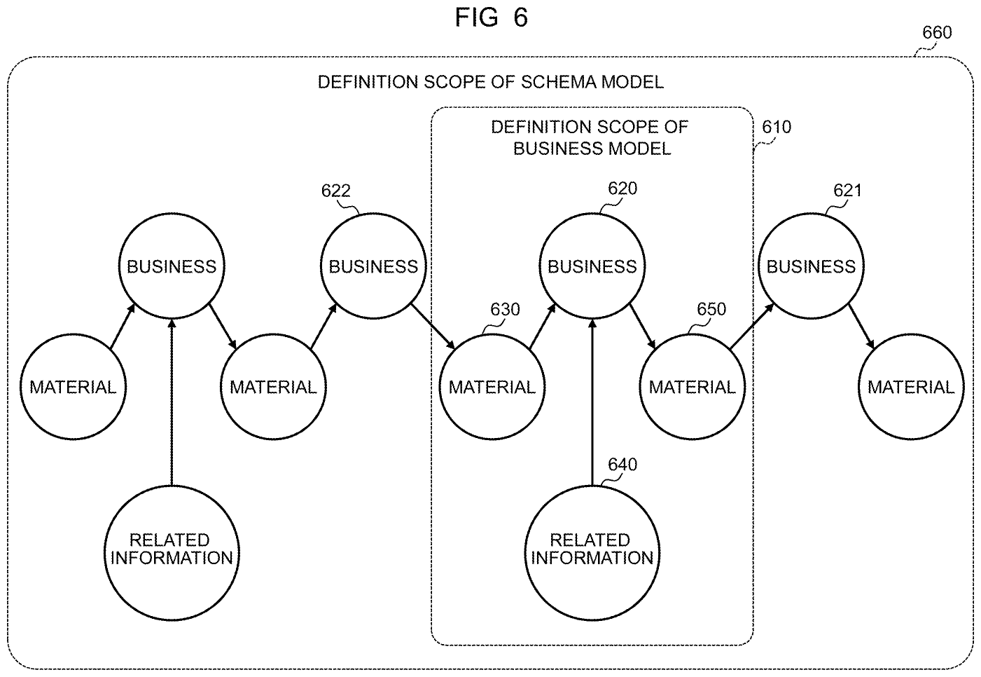

FIG. 6 is a diagram showing a configuration example of a schema model 660. Note that, as described above, there are cases where the schema model is also referred to as the process model. The schema model 660 is a representation of the relationship of the input product node as a material of the product of a certain business node and the finished product as an output product node of that business, and the relationship of the corresponding business node and related information such as on-site data, using an edge which connects them with an arrow.

The schema model 660 includes a definition scope 610 of the business model. In this schema model 660, as the definition scope 610 of the business model, a business node 622 corresponding to its pre-process is connected as an input by an edge, and a business node 621 corresponding to its post-process is connected as an output by an edge.

The definition scope 610 of the business model includes one business node 620. As the definition scope 610 of the business model, a material node 630 is connected as an input product of its business node 620 by an edge, and related information 640 is connected to the business node 620 by an edge, and a material node 650 is connected as an output product of its business node 620 by an edge.

FIG. 7 is a diagram showing an example of the performance instance 710. The illustrated example shows, for instance, an example of the definition scope of a performance instance 710 concerning a product A. The performance instance 710, as described above, is to be created by the performance instance creation unit 260 (see FIG. 2). Here, as an example, explained is a case where the performance instance 710 includes the two business nodes of a business node 721 and a business node 722.

With the business node 721, a material node 741 as an input product and a material node 742 as an output product are connected by an edge shown with an arrow. With the business node 721, for example, the business identifier is “act_001”, and the work date/time is “2019 Jan. 1 10:00:00”. The part identifier of the material node 741 is, for example, “material_000”. The part identifier of the material node 742 is, for example, “material_001”.

With the business node 722, a material node 742 as an input product and a material node 743 as an output product are connected by an edge shown with an arrow. With the business node 722, for example, the business identifier is “act_002”, and the work date/time is “2019 Jan. 1 10:00:00”. The part identifier of the material node 742 is “material_001”. The part identifier of the material node 743 is “material_001”.

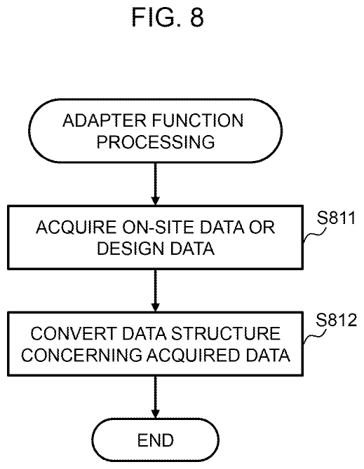

FIG. 8 is a flowchart showing an example of the routine of the adapter function processing. The adapter function processing is processing to be executed by the adapter function unit 210. In step S811, the adapter function unit 210 acquires at least one of either the on-site data or the design data according to the instructions from the operation terminal 180. In step S802, the adapter function unit 210 converts the data structure of each data based on the acquired on-site data or design data.

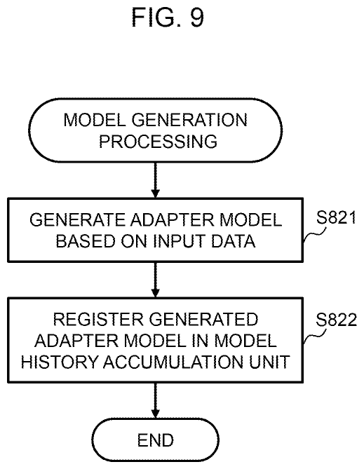

FIG. 9 is a flowchart showing an example of the routine of the model generation processing. This model generation processing is processing to be executed by the model generation unit 220. In step S821, the model generation unit 220 generates the adapter model described later based on the input data described above. In step S822 the model generation unit 220 registers the generated adapter model in the model history accumulation unit 230.

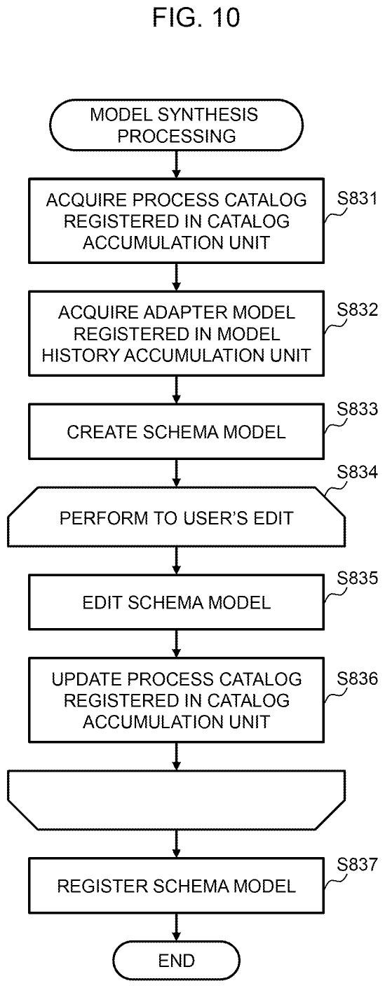

FIG. 10 is a flowchart showing an example of the routine of the model synthesis processing. This model synthesis processing is processing to be executed by the model synthesis unit 250. In step S831, the model synthesis unit 250 acquires the process catalog that has been registered in the catalog accumulation unit 240. In step S832, the model synthesis unit 250 acquires the adapter model that has been registered in the model history accumulation unit 230.

In step S833, the model synthesis unit 250 creates a schema model by using the adapter model and converting the data structure of the process model of each business system.

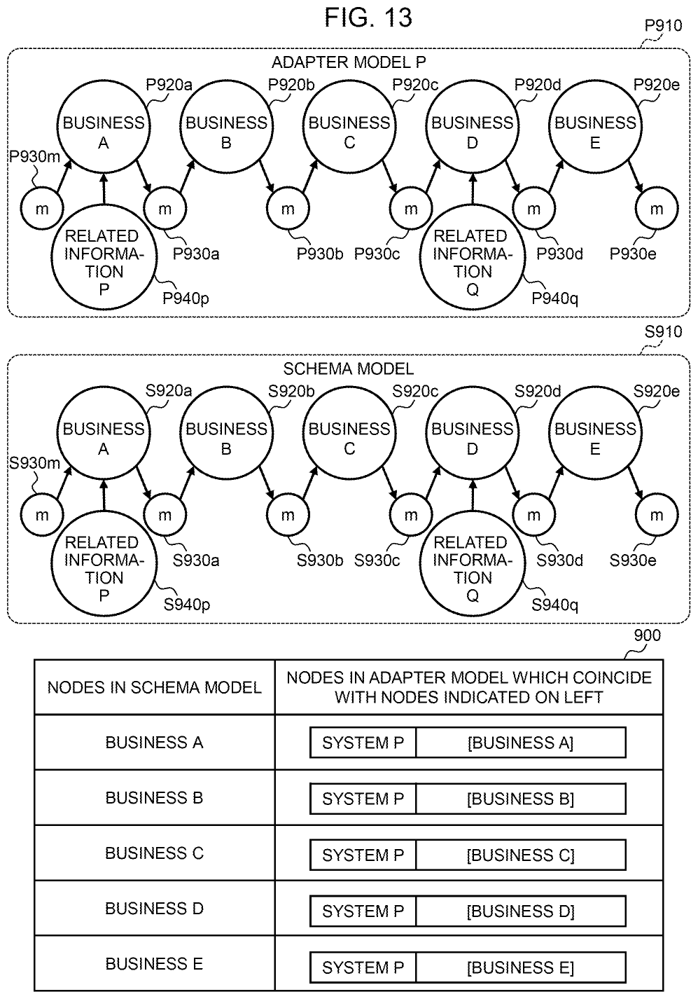

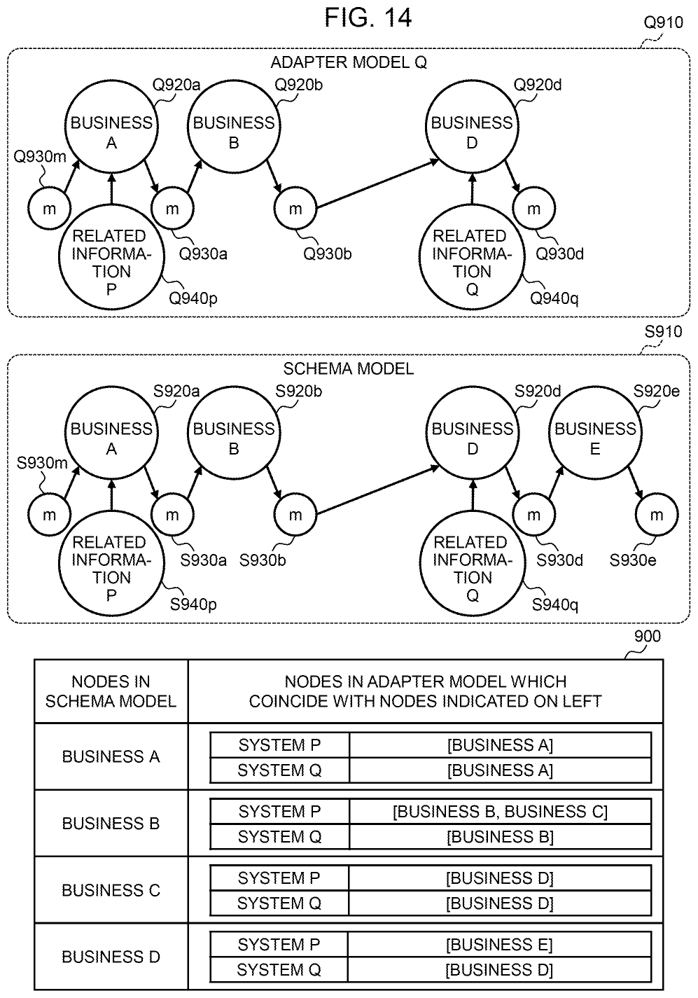

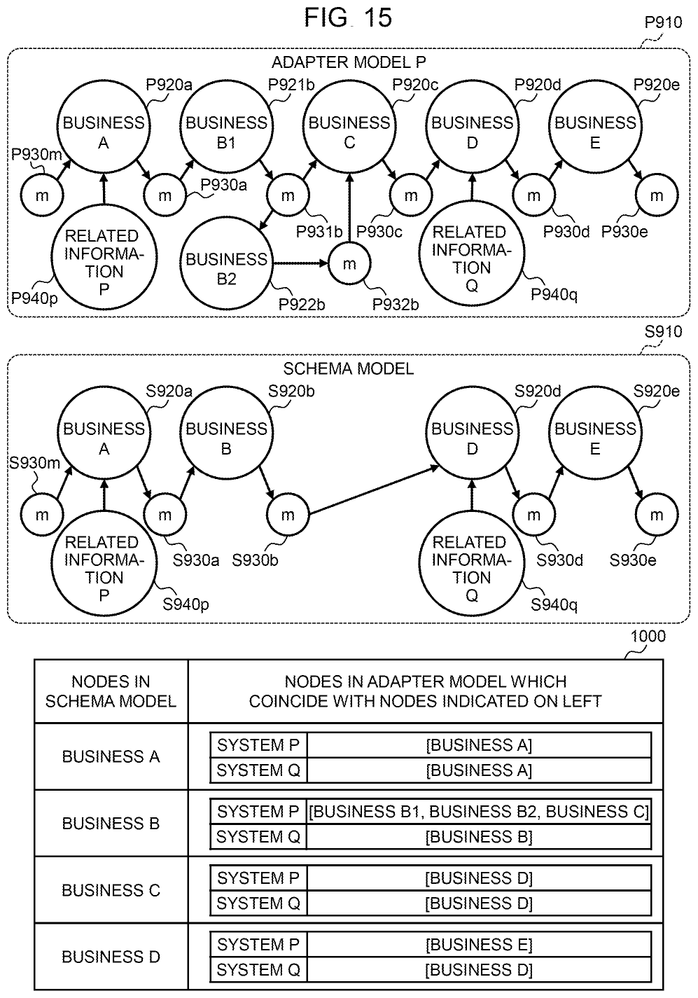

In step S834, the model synthesis unit 250 repeatedly executes step S835 and step S836 until the user completes the editing process. In step S835, the model synthesis unit 250 edits the schema model. In step S836, the model synthesis unit 250 updates (see lower part of FIG. 15 described later) the process catalog that has been registered in the catalog accumulation unit 240 (see FIG. 9, lower part of FIG. 13 and lower part of FIG. 14 described later).

In step S837, the model synthesis unit 250 registers the schema model in the relevance data model accumulation unit 150.

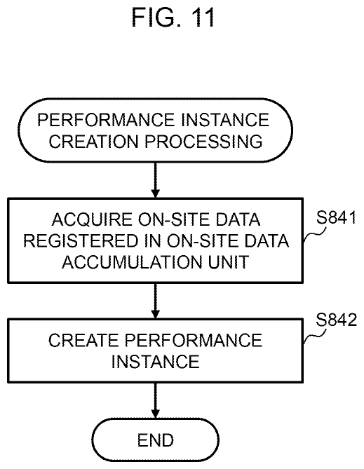

FIG. 11 is a flowchart showing an example of the routine of the performance instance creation processing. This performance instance creation processing is executed by the performance instance creation unit 260. In step S841, the performance instance creation unit 260 acquires the on-site that that has been registered in the on-site data accumulation unit 141. In step S842, the performance instance creation unit 260 creates a performance instance.

In the present embodiment, the adapter function unit 210 is an example of the data structure conversion unit, and converts each data that differs for each business system to coincide with the data structure of the common BOP so that the data structure of each data of each business system will be common.

In the present embodiment, the adapter function unit 210 converts data (on-site data, design data) that differs for each business system to coincide with the data structure of the common BOP. Note that the hierarchy of the process flow defined in the business system and the hierarchical mapping of process-business in the common BOP may be configured so that they can be edited by the user.

Moreover, in the present embodiment, the adapter function unit 210 is an example of the data structure conversion unit, and redefines the common BOP that is common to the BOP that links each data.

Moreover, the model synthesis unit 250 is an example of the process model synthesis unit, and adjusts, based on the foregoing differences, each process definition in each business system, and generates a schema model as a synthesis process model from each of the adjusted process definitions (process catalog).

In the present embodiment, the process model creation system 110 estimates a schema model and generates a synthesis process model based on the following example of the process catalog from the differences between a plurality of adapter models.

FIG. 12 is a diagram showing an example of the process catalog. The illustrated process catalog shows a node, for each node in the schema model, in the adapter model that coincides with the corresponding node. For example, the process catalog shows that it is estimated that a node of a business (1) of a business system I or a node of a business A of a business system II corresponds to a node of a business a of the schema model. The process catalog shows that it is estimated that a node of a business (2) of a business system I or a business B1-L1, business B2-L1, business B1-L2, or business B2-L2 of a business system II corresponds to a node of a business b of the schema model.

FIG. 13 is a diagram showing a creation example of the process catalog. The illustrated example shows an example at the time of initial construction. The adapter model P910 at the time of initial construction includes a node P920a of a business A, a node P920b of a business B, a node P920c of a business C, a node P920d of a business D, and a node P920e of a business D.

In the adapter model P910 at the time of initial construction, a node P940p of related information P is also connected in addition to a material node P930m as an input product of the node P920a of the business A, and a material node P930a is connected as an output product.

A material node P930a is connected to the node P920b of the business B as an input product of the node P920b of the business B, and a material node P930b is connected to the node P920b of the business B as its output product. A material node P930b is an input product of the node P920c of the business C, and a material node P930c is connected to the node P920c of the business C as its output product.

The material node P930c is connected to the node P920d of the business D as an input product of the node P920d of the business D, and a material node P930d is connected to the node P920d of the business D as its output product. Related information P940q is connected to the node P920d of the business D. The material node P930d is an input product of the node P920e of the business E, and a material node P930e is connected to the node P920e of the business E as its output product.

The adapter model P910 at the time of initial construction coincides with the schema model S910 in terms of format (excluding the reference numerals).

The process catalog 900 is managing, for each node in the schema model, the node in the adapter model that coincides with the corresponding node. The model synthesis unit 250 performs the estimation in the following manner. It is estimated that the node S920a of the business A of the system (adapter model) P corresponds to the node P920a of the business A of the schema model. It is estimated that the node S920b of the business B of the system (adapter model) P corresponds to the node P920b of the business B of the schema model. It is estimated that the node S920c of the business C of the system (adapter model) P corresponds to the node of the business C of the schema model. It is estimated that the node S920d of the business D of the system (adapter model) P corresponds to the node of the business D of the schema model. It is estimated that the node S920e of the business E of the system (adapter model) P corresponds to the node S920e of the business E of the schema model.

FIG. 14 is a diagram showing a creation example of the process catalog. The illustrated example shows an example at the time of initial construction. An adapter model Q910 at the time of initial construction includes a node Q920a of a business A, a node Q920b of a business B, and a node Q920d of a business D. In other words, the process catalog shown in FIG. 14 differs from the process catalog of FIG. 13, in terms of format (excluding the reference numerals), with respect to the point that the node P920c of the business C has been omitted.

In the adapter model Q910 at the time of initial construction, a node Q940p of the related information P is connected in addition to a material node Q930m as an input product of the node Q920a of the business A, and a material node Q930a is connected as an output product.

The material node Q930a is connected to the node Q920b of the business B as an input product of the node Q920b of the business B, and a material node Q930b is connected to the node Q920b of the business B as its output product. The material node Q930b is an input product of the node Q920d of the business D, and a material node P930d is connected to the node Q920d of the business D as its output product. Related information P940q is connected to the node of the business D.

The adapter model P910 at the time of initial construction does not coincide with the node schema model S910 of the business E in terms of format of the process catalog, and the node S920e of the business E and a material node S930e as its output product have been added.

As described above, the process catalog 900 is managing, for each node in the schema model, the node in the adapter model that coincides with the corresponding node. The model synthesis unit 250 performs the estimation in the following manner. It is estimated that the node Q920a of the business A of the system (adapter model) P corresponds to the node S920a of the business A of the schema model. It is estimated that the node Q920b of the business B of the system (adapter model) P corresponds to the node S920b of the business B of the schema model.

It is estimated that the node P920d of the business D of the system (adapter model) P corresponds to the node S920d of the business D of the schema model. If the node Q920e of the business E of the system (adapter model) P exists, then it is estimated that the node Q920e of the business E should have originally corresponded to the node S920e of the business E of the schema model.

FIG. 15 is a diagram showing a creation example of the process catalog. The illustrated example shows an example at the time of update. An adapter model Q910 at the time of update includes a node Q920a of a business A, a node Q921b of a business B1, a node Q922b of a business B2, a node Q920c of a business C, a node Q920d of a business D, and a node Q920e of a business E. In other words, the process catalog shown in FIG. 15 differs from the process catalog of FIG. 13 with respect to the point that the node Q921b of the business B1 and the node Q922b of the business B2 are provided in substitute for the node P920b of the business B. The differences in comparison to the example shown in FIG. 13 are now mainly explained.

In the adapter model Q910 at the time of update, a material node Q930a as an output product of the node Q920a of the business A is connected to the node Q921b of the business B1 as an input product of the node Q921b of the business B1, and a material node P931b is connected as an output product of the node Q921b of the business B1. The material node P931b is connected as an input product of the business B2, and a material node P932b is connected as an output product of the business B2.

Meanwhile, the schema model S910a at the time of update mainly differs from the schema model S910 at the time of initial construction shown in FIG. 13, in terms of format, with respect to the point that the node S920c of the business C is omitted. Accordingly, it could be said that the schema model S910a at the time of update has a different granularity of definition of the manufacturing process in comparison to the adapter model Q910 at the time of update.

As described above, the process catalog 1000 is managing, for each node in the schema model, the node in the adapter model that coincides with the corresponding node. The model synthesis unit 250 performs the estimation in the following manner. It is estimated that the node S920a of the business A of the system (adapter model) P corresponds to the node S920a of the business A of the schema model. It is estimated that the node S921b of the business B1, the node S922b of the business B2 and the node P920c of the business C of the system (adapter model) P correspond to the node P920b of the business B of the schema model.

It is estimated that the node P920d of the business D of the system (adapter model) P corresponds to the node P920d of the business D of the schema model. It is estimated that the node P920e of the business E of the system (adapter model) P corresponds to the node P920e of the business E of the schema model.

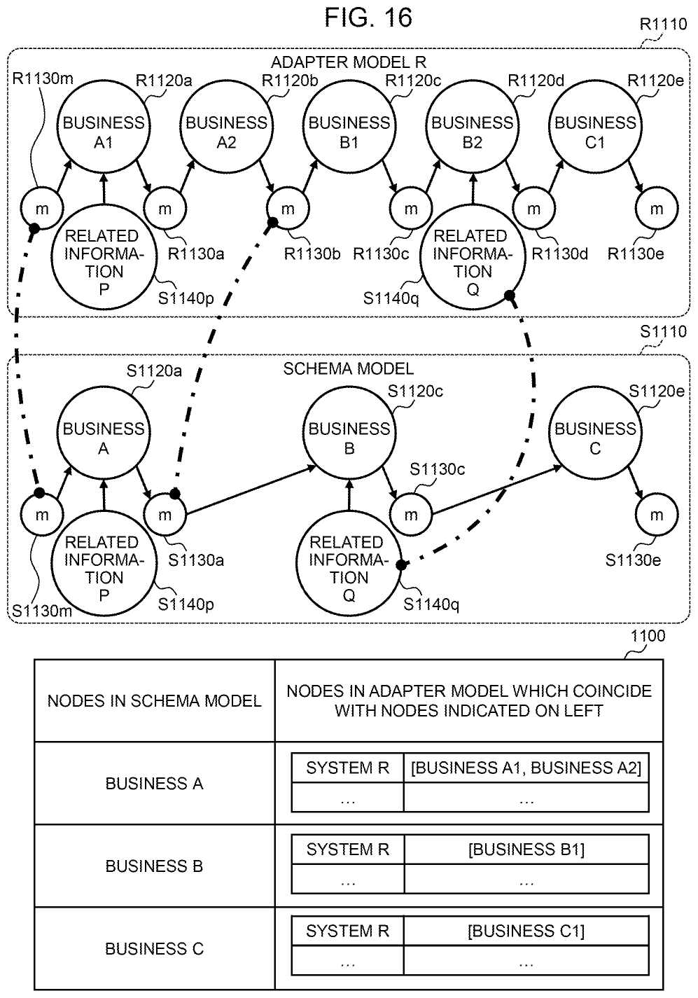

FIG. 16 is a diagram showing an assistance example in creating the process catalog. An adapter model R1110 includes a node R1120a of a business A1, a node R1120b of a business A2, a node R1120c of a business B1, a node R1120d of a business B2, and a node R1120e of a business C1.

In the adapter model R1110, a node R1140p of related information P is connected in addition to a material node R1130m as an input product of the node R1120a of the business A1, and a material node R1130a is connected as an output product.

The material node R1130a is connected to the node R1120b of the business A2 as an input product of the node R1120b of the business A2, and a material node R1130b is connected to the node R1120b of the business A2 as its output product. The material node R1130b is an input product of a node R1120c of the business B1. A material node R1130c is connected to the node R1120c of the business B1 as its output product. A material node R1130c is an input product of a node R1120d of the business B2. A node R1140q of related information Q is connected to the node R1120d of the business B2. A material node R1130d is connected to the node R1120d of the business B2 as its output product.

The material node R1130d is connected to a node R1120e of the business C1 as an input product of the node R1120e of the business C1, and a material node R1130e is connected to the node R1120e of the business C1 as its output product.

The adapter model R1110 does not coincide with the schema model S1110 in terms of format (excluding the reference numerals).

The process catalog 1100 is managing, for each node in the schema model, the node in the adapter model that coincides with the corresponding node. Based on the estimation shown with the dashed-dotted line, it is estimated that the node R1120a of the business A1 and the node R1120b of the business A2 of the system (adapter model) R correspond to the node S1120a of the business A of the schema model.

Based on the estimation shown with the dashed-dotted line, it is estimated that the node R1120c of the business B1 and the node Q1120d of the business B2 of the system (adapter model) R correspond to the node S1120b of the business B of the schema model.

Based on the estimation shown with the dashed-dotted line, it is estimated that the node R1120e of the business C1 of the system (adapter model) R corresponds to the node S1120b of the business C of the schema model.

As a result of the model synthesis unit 250 estimating the correlation of businesses of the adapter model and the schema model in the manner described above, it is possible to adjust the differences between the schema models (process models) of each business system and create a common synthesis process model with each business system.

The process model creation system 100 according to the present embodiment described above comprises an adapter function unit 210 as an example of the data structure conversion unit which converts each data of each business system into a data structure of a common BOP (Bill of Process), a model generation unit 220 which creates a plurality of adapter models from the data structure of the common BOP, and a model synthesis unit 250 as an example of the process model synthesis unit which extracts differences between the plurality of adapter models and creates a synthesis process model.

Moreover, in the present embodiment, the adapter function unit 210 as an example of the data structure conversion unit of the process model creation system executes a data structure conversion step of converting each data of each business system into a data structure of a common BOP (Bill of Process), the model generation unit 220 of the process model creation system 100 executes a model generation step of creating a plurality of adapter models from the data structure of the common BOP, and the process model synthesis unit 250 of the process model creation system 100 executes a process model synthesis step of extracting differences between the plurality of adapter models and creating a synthesis process model.

As a result of adopting the foregoing configuration, because there is no need to generate a process model for each of a plurality of business systems and it will be sufficient for a synthesis process model to be generated, it is possible to reduce the man-hours required for generating a process model in correspondence with each business process.

In the present embodiment, the adapter function unit 210 converts each data that differs for each of the business systems to coincide with the data structure of the common BOP so that the data structure of each data of each business system will be common. As a result of adopting the foregoing configuration, because there is no need to generate a process model for each of a plurality of business systems and it will be sufficient for a synthesis process model to be generated from the adapter model of the adapter function unit 210, it is possible to reduce the man-hours required for generating a process model in correspondence with each business process.

Moreover, in the present embodiment, the adapter function unit 210 is an example of the data structure conversion unit, and redefines the common BOP that is common to the BOP that links each data. As a result of adopting the foregoing configuration, because there is no need to generate a process model for each of a plurality of business systems and it will be sufficient for a synthesis process model to be generated from the common BOP, it is possible to reduce the man-hours required for generating a process model in correspondence with each business process.

Moreover, the model synthesis unit 250 is an example of the process model synthesis unit, and adjusts, based on differences between a plurality of adapter models, each process definition in each of the business systems, and generates a schema model as the synthesis process model from each of the adjusted process definitions. As a result of adopting the foregoing configuration, because there is no need to generate a process model for each of a plurality of business systems and it will be sufficient for a synthesis process model to be generated from each process definition, it is possible to reduce the man-hours required for generating a process model in correspondence with each business process.

Moreover, in the present embodiment, as a mode of use of the common BOP, a catalog creation assistance unit recommends that the businesses linked by related information concerning businesses coincide, and assists the creation of a process catalog. As a result of adopting the foregoing configuration, the process model can be easily created.

### (3) Other Modified Examples

Note that, in the present embodiment, while the process model creation system 110 was provided to the business operator A, the present invention is not limited thereto, and the process model creation system 110 may also be provided to another business operator, such as one among the business operator B, the business operator C1, and the business operator C2.

### INDUSTRIAL APPLICABILITY

The present invention can be applied to a process model creation system for creating a process model capable of linking on-site data and design data from on-site data generation devices arranged in the factory's production equipment.

Note that, in the embodiment explained above, while an example of the manufacturing process at the manufacturing site was explained, the process model creation system 110 can also be applied to an arbitrary business category where a plurality of business systems, which is configured from a plurality of businesses, is operating, without limitation to manufacturing sites. For example, in the logistics business or the transport business, a plurality of processes configuring the transport process from the receipt of baggage to their sorting, storage, packaging and shipment exists, and the creation of a transport process model from the on-site data and the plan data concerning the transport process can be performed in the same manner as creating a process model at a manufacturing site.

### REFERENCE SIGNS LIST

110 . . . process model creation system, 120 . . . network, 130a, 130b . . . data generation device, 141a, 141b . . . on-site data accumulation unit, 142a, 142b design data accumulation unit, 150 . . . relevance data model accumulation unit, 160 . . . relevance data accumulation unit, 180 . . . operation terminal.

1. A process model creation system, comprising:
a data structure conversion unit which converts each data of each business system into a data structure of a common BOP (Bill of Process);
a model generation unit which creates a plurality of adapter models from the data structure of the common BOP; and
a process model synthesis unit which extracts differences between the plurality of adapter models and creates a synthesis process model.

2. The process model creation system according to claim 1, wherein:
the data structure conversion unit converts each data that differs for each of the business systems to coincide with the data structure of the common BOP so that the data structure of each data of each of the business systems will be common.

3. The process model creation system according to claim 1, wherein:
the data structure conversion unit redefines, based on the differences, the common BOP that is common to the BOP that links each data that differs for each of the business systems.

4. The process model creation system according to claim 1, wherein:
the process model synthesis unit adjusts, based on the differences, each process definition in each of the business systems, and generates the synthesis process model from each of the adjusted process definitions.

5. The process model creation system according to claim 1, wherein:
each data of each of a plurality of business systems of the manufacturing site is each one of BOP, on-site data, and design data.

6. The process model creation system according to claim 1, further comprising:
a catalog creation assistance unit which recommends, as a mode of use of the common BOP, that the businesses linked by related information concerning businesses coincide, and assists the creation of a process catalog.

7. A process model creation method in a process model creation system, comprising:
a data structure conversion step of a data structure conversion unit of the process model creation system converting each data of each business system into a data structure of a common BOP (Bill of Process);
a model generation step of a model generation unit of the process model creation system creating a plurality of adapter models from the data structure of the common BOP; and
a process model synthesis step of a process model synthesis unit of the process model creation system extracting differences between the plurality of adapter models and creating a synthesis process model.

8. The process model creation method according to claim 7, wherein:
in the data structure conversion step, the data structure conversion unit converts each data that differs for each of the business systems to coincide with the data structure of the common BOP so that the data structure of each data of each of the business systems will be common.

9. The process model creation method according to claim 7, wherein:
in the data structure conversion step, a redefinition unit redefines the common BOP that is common to the BOP that links each of the data.

10. The process model creation method according to claim 7, wherein:
the process model synthesis unit adjusts, based on the differences, each process definition in each of the business systems, and generates the synthesis process model from each of the adjusted process definitions.

11. The process model creation method according to claim 7, wherein:
each data of each of a plurality of business systems of the manufacturing site is each one of BOP, on-site data, and design data.

12. The process model creation method according to claim 7, wherein:
a catalog creation assistance unit includes a catalog creation assistance step of recommending, as a mode of use of the common BOP, that the businesses linked by related information concerning businesses coincide, and assisting the creation of a process catalog.

13. A process model creation program which causes a computer to execute:
a data structure conversion step of causing a data structure conversion unit of the process model creation system to convert each data of each business system into a data structure of a common BOP (Bill of Process);
a model generation step of causing a model generation unit of the process model creation system to create a plurality of adapter models from the data structure of the common BOP; and
a process model synthesis step of causing a process model synthesis unit of the process model creation system to extract differences between the plurality of adapter models and create a synthesis process model.
